(19) United States
(12) Patent Application Publication
(10) Pub. No.: US 2006/0080431 A1
(43) Pub. Date: Apr. 13, 2006

(54) MP3 headphone structure

(76) Inventor: Cheng-Hsien Chao, Taipei City (TW)

Correspondence Address: Cheng-Hsien CHAO, P. O. Box No. 6-57, Junghe, Taipei, 235, TW

(21) Appl. No.: 10/960,913

(22) Filed: Oct. 12, 2004

(51) Int. Cl. G06F 15/173

(52) U.S. Cl. 709/224

(57) ABSTRACT

The present invention relates to a headphone including a headband with an ear covering and a fixing seat formed each side, wherein, a battery groove formed at one fixing seat and a circuit board with MP3, radio, and amplified circuits, a control key and a microphone formed at the other fixing seat. With an outlet connecting with a computer to download MP3 programs, the headphone can be used to listen in to MP3 programs, besides the radio option, with a button corresponding to the control key formed on a lid for making a selection of MP3 programs or radio channels. When connecting a cable to the computer, the headphone with the microphone can be used in the video conference.

### BACKGROUND OF THE INVENTION

(a) Field of the Invention

The present invention is related to a MP3 headphone with enhanced functions, and more particularly to a multi-functional headphone of being a MP3, or a radio, or a conventional headphone.

(B) Description of the Prior Art

A conventional headphone includes a headband and ear coverings, wherein a cable is made to connect to a stereo or a computer. Besides serving as an audible device when connecting to a loaded MP3, the headphone does not serve other purposes, which is not convenient.

### SUMMARY OF THE INVENTION

The present invention relates to an improved MP3 headphone structure that allows the headphone to be able to listen in to a MP3 or a radio alone and also able to connect with a stereo to listen in to music or with a computer for a video conference.

The present invention comprises a headband with an ear covering and a fixing seat formed each end, wherein a battery groove formed at one fixing seat and a MP3 and radio circuit board, a control key, and an USB outlet formed at the other, to be connected with a computer to download MP3 programs to the circuit board, thereby enabling the headphone to play MP3 programs or to serve as a radio.

The headphone structure according to the above, wherein an amplified circuit connecting with a microphone formed on the circuit board, thereby enabling the headphone to receive and transmit radio-wave when in the video conference.

The headphone structure according to the above, wherein an outlet connecting with the circuit board formed, to be connected with the stereo or the computer, thereby forming a conventional headphone.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows a perspective view of the present invention.

FIG. 2 shows an exploded elevational view of the present invention.

FIG. 3 shows another exploded elevational view of the present invention.

FIG. 4 shows a view of the present invention in use.

FIG. 5 shows another view of the present invention in use.

### DETAILED DESCRIPTION OF THE PREFERRED EMBODIMENTS

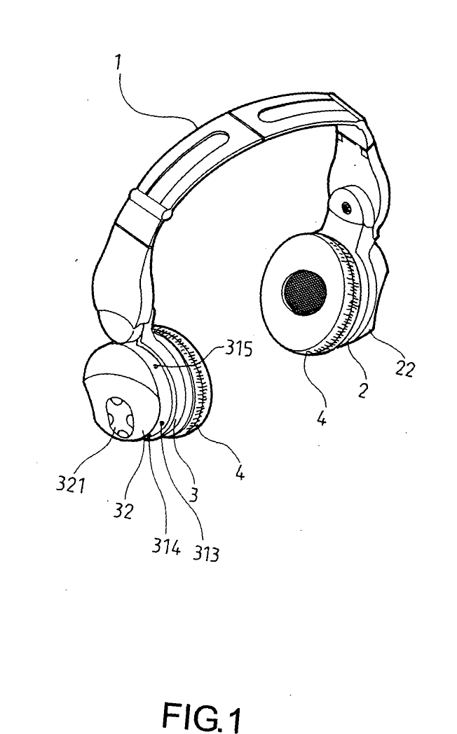

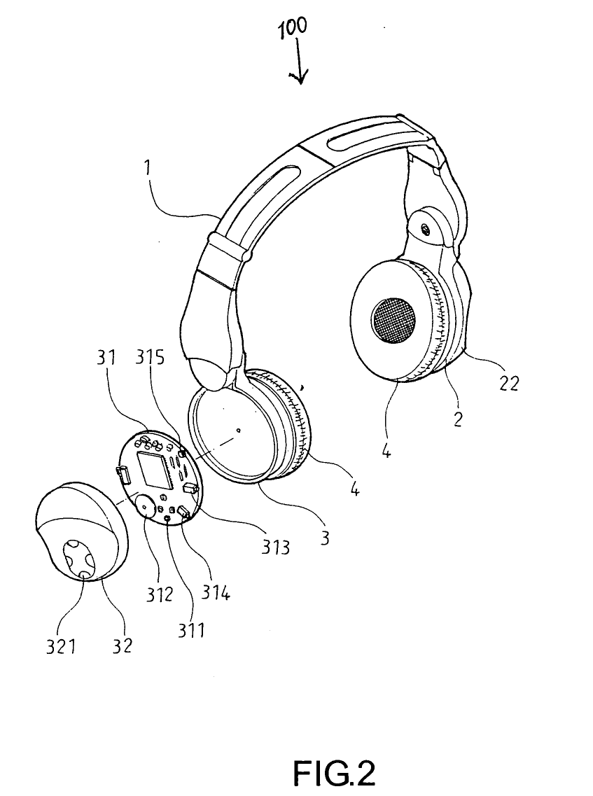

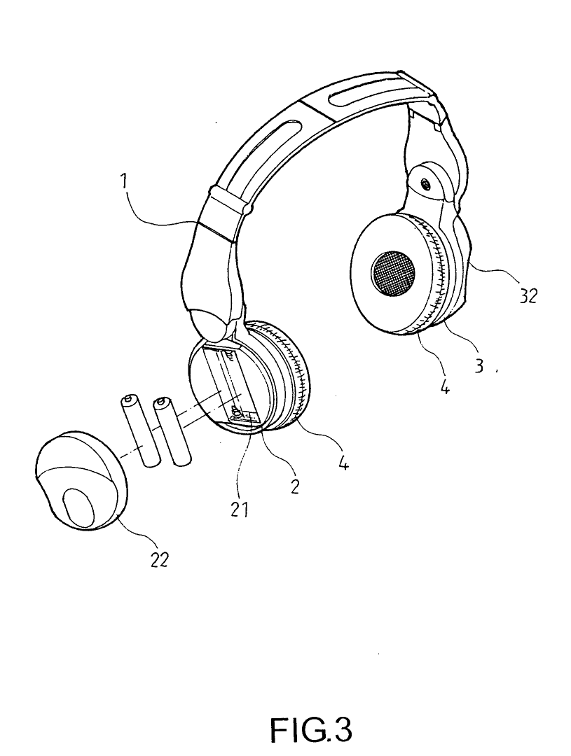

Referring to FIGS. 1˜3. The present invention comprises a headband 1 with an ear covering 4 and a fixing seat 2 (or 3) formed each end, wherein a battery groove 21 formed at the fixing seat 2 and a MP3 and radio circuit board 31 formed at the fixing seat 3, with a control key 311, a volume control roller 312, an USB outlet 313, an outlet 314, and a microphone 315 formed thereof. The power for the circuit board 31 is supplied by batteries through a wire inside the headband 1. Outer lids 22 and 32 are formed to cover fixing seats 2 and 3, respectively, wherein a button 321, corresponding to the control key 311, formed on the lid 32.

With the above structure, a headphone 100 is thereby formed, wherein the USB outlet 313 connecting with a computer to download MP3 programs to the circuit board 31, thereby enabling to listen in to MP3 programs through the ear coverings 4, with the button 321 to make a selection of MP3 programs or radio channels when listening in to the radio. Through the outlet 314, the microphone 315 on the headphone 100 can be used in the video conference when connecting with the computer or to listen in to music when connecting with the stereo.

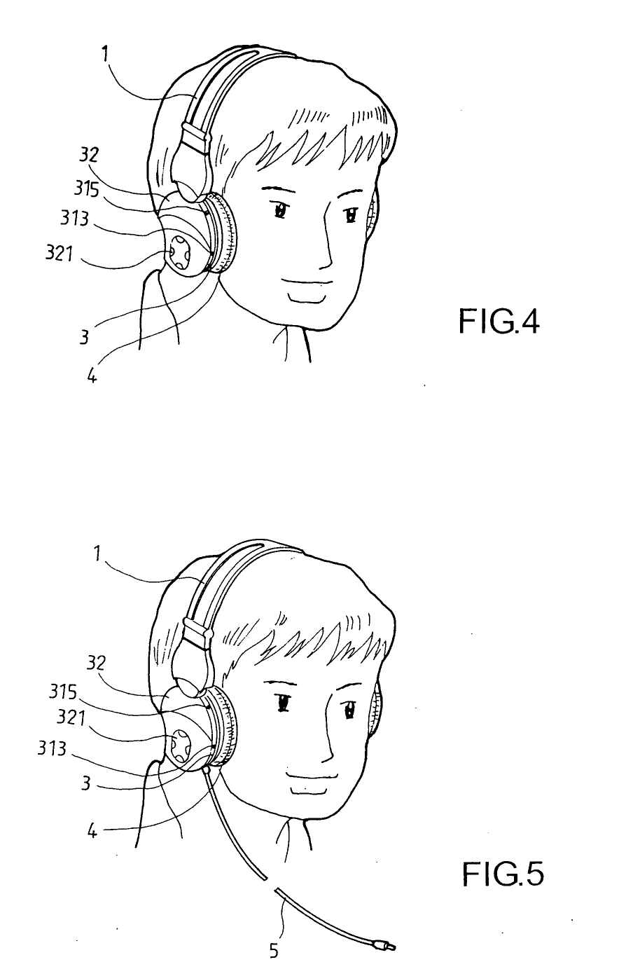

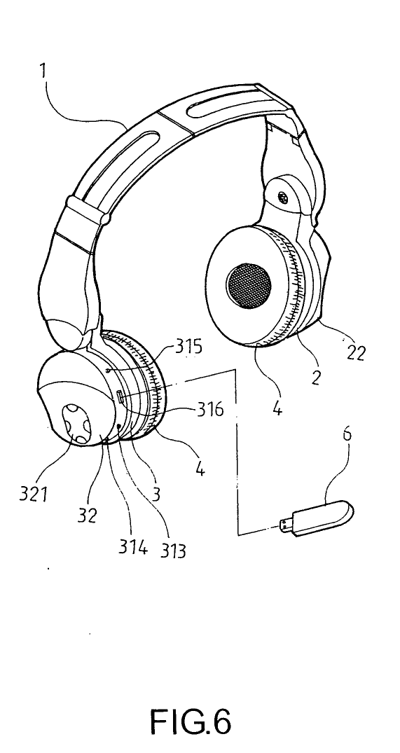

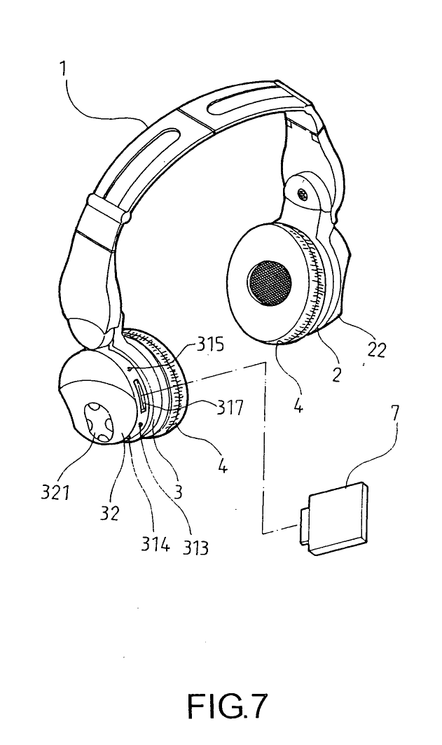

Referring to FIG. 4. An individual is listening in to the MP3 or radio programs through ear covering 4 of the headphone 100 without an external cable, thereby making the listening much convenient.

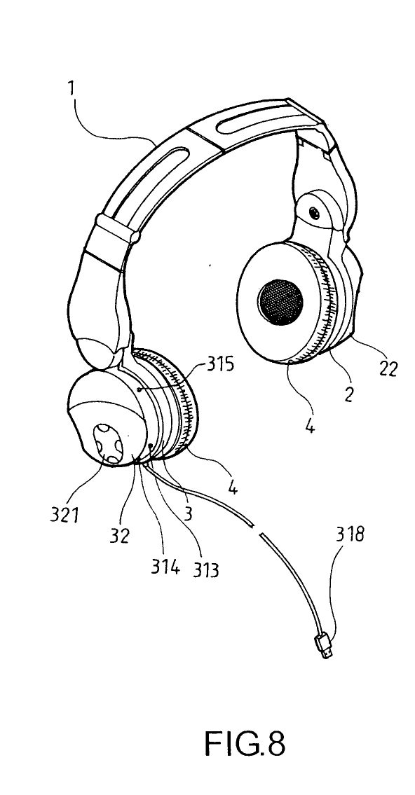

Referring to FIG. 5. Through a cable 5, the microphone 315 formed inside the headphone 100 can be used in the video conference when connecting with the computer or to listen in to music when connecting with the stereo.

In summary, with the MP3, radio, microphone circuit incorporated, the present invention is indeed a multi-functional and pragmatic headphone.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A headphone comprising a headband with an ear covering and a fixing seat formed each side, wherein, a battery groove formed at one fixing seat and a circuit board with MP3, radio, and amplified circuit formed at the other fixing seat, with a control key, a volume control roller, an USB outlet, an outlet, and a microphone formed thereof, thereby enabling to use ear coverings to listen in to the radio or MP3 programs downloaded from a computer, or to use in the video conference when connecting with the computer, or to listen in to music when connecting with the stereo.

2. The headphone according to claim 1, wherein outer lids formed to cover fixing seats, with a button corresponding to the control key to make a selection of MP3 programs or radio channels.
